(19) United States
(12) Patent Application Publication
(10) Pub. No.: US 2016/0377752 A1
(43) Pub. Date: Dec. 29, 2016

(54) Method of Digitally Identifying Structural Traps

(71) Applicants: Claude Edward Francois Cavelius, Mount Lawley (AU); William S. Kowalik, Applecross (AU); Antony J. Marsh, Salter Point (AU); Jerome Amiotte, Subiaco (AU)

(72) Inventors: Claude Edward Francois Cavelius, Mount Lawley (AU); William S. Kowalik, Applecross (AU); Antony J. Marsh, Salter Point (AU); Jerome Amiotte, Subiaco (AU)

(73) Assignee: Chevron U.S.A. Inc., San Ramon, CA (US)

(21) Appl. No.: 14/751,253

(22) Filed: Jun. 26, 2015

(51) Int. Cl. G01V 1/30; G01V 1/34

(52) U.S. Cl. CPC G01V 1/30; G01V 1/34; G01V 2210/64

(57) ABSTRACT

Embodiments of methods of identifying structural traps are disclosed herein. Embodiments of the disclosed method use an alternative approach to boundary value problem solvers, based on simple mathematical geometry adapted to the nature of the acquired data. Embodiments of the method rely on digital elevation model type of data (i.e. any given subsurface horizon has only single elevation data values). The disclosed methods allow for a significant algorithm speed-up in identifying structural traps especially when handling large and high density datasets which was heretofore not possible with existing methods.

### CROSS-REFERENCE TO RELATED APPLICATIONS

Not applicable.

### STATEMENT REGARDING FEDERALLY SPONSORED RESEARCH OR DEVELOPMENT

Not applicable

### BACKGROUND

Field of the Invention

This invention relates generally to the field of geophysical exploration for hydrocarbons. More specifically, the invention relates to methods of identifying structural traps in a digital model based on subsurface data.

Background of the Invention

A seismic survey is a method of imaging the subsurface of the earth by delivering acoustic energy down into the subsurface and recording the signals reflected from the different rock layers below. During a seismic survey, a seismic source may be moved across the surface of the earth above the geologic structure of interest. Each time a source is detonated or activated, it generates a seismic signal that travels downward through the earth, is reflected, and, upon its return, is recorded at different locations on the surface by receivers. The recordings or traces are then combined to create a profile of the subsurface that can extend for many miles. In a two-dimensional (2D) seismic survey, the receivers are generally laid out along a single straight line, whereas in a three-dimensional (3D) survey the receivers are distributed across the surface in a grid pattern. A 2D seismic line provides a cross sectional picture (vertical slice) of the earth layers as arranged directly beneath the recording locations. A 3D survey produces a data “cube” or volume that theoretically represents a 3D picture of the subsurface that lies beneath the survey area.

In general, hydrocarbon resources lay beneath the Earth's surface. Such sub-surface locations are called conventional petroleum prospects and may or may not contain hydrocarbons depending on the following five geological factors: 1) Source rock, which refers to the organic-rich basement rocks are subject to elevated pressure and temperature over a long geologic time period, transforming organic matter into hydrocarbons; 2) Migration in which formed hydrocarbons are expelled from the source rock due to the hydrocarbon lower density and the surrounding high pressure, and start migrating upward and/or laterally through permeable rocks and/or fractures; 3) Reservoir, which refers to the porous rock formation or fracture sets that can potentially collect hydrocarbons; 4) Traps which are geologic configurations that block the movement of hydrocarbons and cause it to accumulate in a reservoir; 5) Seals, which refer to an impermeable rock formation preventing hydrocarbons from escaping to the Earth's surface and containing it in a reservoir trap.

Identifying such structural traps and/or formation in the sub-surface, consists in locating all these dome structures and detecting their base structure (also known as a “spill plane”), level at which hydrocarbons potentially filling the entire structure would start to escape from the trap. Seismic interpreters use seismic data in conjunction with knowledge of the geology such as traps to locate potential hydrocarbon bearing regions in the subsurface. Over large areas (e.g. at a geologic basin scale), it becomes an extremely tedious work to do by manual hand picking or highly computer intensive if automated using boundary value problem solvers (such as fast-marching algorithm, level set methods and ordered upwind methods).

Consequently, there is a need for methods and systems of efficiently and quickly identifying structural traps.

### BRIEF SUMMARY

Embodiments of methods of identifying structural traps are disclosed herein. Embodiments of the disclosed method use an alternative approach to boundary value problem solvers, based on simple mathematical geometry adapted to the nature of the acquired data. Embodiments of the method rely on digital elevation model type of data (i.e. any given subsurface horizon has only single elevation data values). The disclosed methods allow for a significant algorithm speed-up in identifying structural traps especially when handling large and high density datasets which was heretofore not possible with existing methods.

In an embodiment, a method for identifying structural traps comprises (a) inputting a seismic dataset into computer, the seismic dataset representative of a subsurface region of interest, and wherein the seismic dataset comprises at least one or more elevation data points. The method further comprises (b) selecting a horizon from the seismic dataset. In addition, the method comprises (c) determining, using the computer, a plurality of elevation contours from the horizon based on the elevation data points to generate a contour dataset. Furthermore, the method comprises (d) evaluating, using the computer, the plurality of contours to identify one or more structural traps, wherein the one or more structural traps are identified automatically based upon a computer algorithm which uses the elevation data points to identify and classify the one or more structural traps. The method also comprises (e) displaying on the computer one or more contours which represents an outline of the one or more structural traps and (f) using the one or more structural traps identified in (d) to locate potential hydrocarbon-bearing regions in the subsurface region of interest.

In another embodiment, a computer system for identifying structural traps comprises an interface for receiving a seismic input volume, the seismic input volume comprising a plurality of seismic traces. The computer system further comprises a memory resource. In addition, the computer system comprises input and output functions for presenting and receiving communication signals to and from a human user. The computer system also comprises one or more central processing units for executing program instructions and program memory coupled to the central processing unit for storing a computer program including program instructions that when executed by the one or more central processing units, cause the computer system to perform a plurality of operations for identifying structural traps. The plurality of operations comprise: (a) receiving a seismic dataset, the seismic dataset representative of a subsurface region of interest, and wherein the seismic dataset comprises at least one or more elevation data points. The operations further comprise (b) selecting a horizon from the seismic dataset. In addition, the operations comprise (c) determining a plurality of elevation contours from the horizon based on the elevation data points to generate a contour dataset. Furthermore, the operations comprise (d) evaluating the plurality of contours to identify one or more structural traps, wherein the one or more structural traps are identified automatically based upon a computer algorithm which uses the contour dataset. The operations also comprise (e) displaying on the computer one or more contours which represents an outline of the one or more structural traps and (f) using the one or more structural traps identified in (d) to locate potential hydrocarbon-bearing regions in the subsurface region of interest.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a three-dimensional (3D) schematic representation of a seismic volume or a digital elevation model for use with embodiments of the methods for identifying structural traps;

FIG. 2A illustrates a flowchart of an embodiment of the method for identifying structural traps;

FIG. 2B illustrates a flowchart of an algorithm which can be used to evaluate the determined contours;

FIG. 3 illustrates an example of a 4 way structural trap;

FIG. 4 illustrates an example of a 3-way structural trap;

FIG. 5 illustrates a plot for determining closure as used in an embodiment of the method;

FIG. 6 illustrates a visual example of open contours;

FIG. 7 illustrates propagation of a contour along a fault as used in an embodiment of the method;

FIG. 8 illustrates classification of the contours as used in an embodiment of the method;

FIG. 9 illustrates a three-dimensional representation of nested closures as used in an embodiment of the method;

FIG. 10 illustrates a schematic of a system which may be used in conjunction with embodiments of the disclosed methods;

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

As used herein, a “horizon” refers to a distinctive chronostratigraphic layer or bed with a characteristic seismic expression.

As used herein, a “seismic volume,” a “seismic dataset”, a “seismic cube” may be used interchangeably to refer to a volume of seismic data (of any geometry) representing a subsurface or subterranean region of interest.

As used herein, “seismic trace” refers to the recorded data from a single seismic recorder or seismograph and typically plotted as a function of time or depth.

### DETAILED DESCRIPTION OF THE PREFERRED EMBODIMENTS

Referring now to the Figures, embodiments of the disclosed methods will be described. As a threshold matter, embodiments of the methods may be implemented in numerous ways, as will be described in more detail below, including for example as a system (including a computer processing system), a method (including a computer implemented method), an apparatus, a computer readable medium, a computer program product, a graphical user interface, a web portal, or a data structure tangibly fixed in a computer readable memory. Several embodiments of the disclosed methods are discussed below. The appended drawings illustrate only typical embodiments of the disclosed methods and therefore are not to be considered limiting of its scope and breadth.

Embodiments of the disclosed methods assume a plurality of seismic traces have been acquired as a result of a seismic survey using any methods known to those of skill in the art. A seismic survey may be conducted over a particular geographic region whether it be in an onshore or offshore context. A survey may be a three dimensional (3D) or a two dimensional (2D) survey. The raw data collected from a seismic survey are unstacked (i.e., unsummed) seismic traces which contain digital information representative of the volume of the earth lying beneath the survey. Methods by which such data are obtained and processed into a form suitable for use by seismic processors and interpreters are well known to those skilled in the art. Additionally, those skilled in the art will recognize that the processing steps that seismic data would normally go through before it is interpreted: the choice and order of the processing steps, and the particular algorithms involved, may vary markedly depending on the particular seismic processor, the signal source (dynamite, vibrator, etc.), the survey location (land, sea, etc.) of the data, and the company that processes the data.

The goal of a seismic survey is to acquire a set of seismic traces over a subsurface target of some potential economic importance. Data that are suitable for analysis by the methods disclosed herein might consist of, for purposes of illustration only, a 2-D stacked seismic line extracted from a 3-D seismic survey or, a 3-D portion of a 3-D seismic survey. However, it is contemplated that any 3-D volume of seismic data might potentially be processed to advantage by the methods disclosed herein. Although the discussion that follows will be described in terms of traces contained within a stacked and migrated 3-D survey, any assembled group of spatially related seismic traces could conceivably be used (from either 2D or 3D surveys). After the seismic data are acquired, they are typically brought back to the processing center where some initial or preparatory processing steps are applied to them.

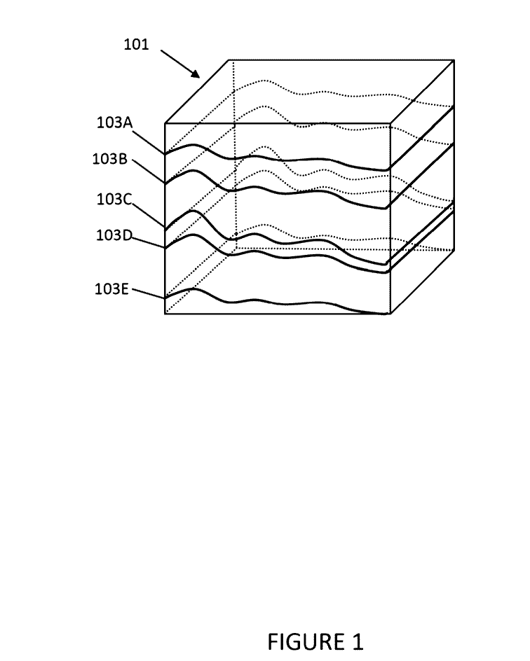

The methods disclosed herein may be applied at the data interpretation stage, the general object of the disclosed methods being to use the seismic datasets by the interpreter in his or her quest for subterranean exploration formations. It might also contain other attributes that are correlated with seismic hydrocarbon indicators. FIGS. 1-9 illustrate visually an embodiment of a method and include a flow chart that illustrates an embodiment of the disclosed methods.

Referring now to FIGS. 1-9, in an embodiment, the method 200 of digitally identifying structural traps is shown in flowchart 200. The seismic datasets may be processed in accordance with standard techniques and formatted into seismic data volumes or “cubes” 101 as shown in FIG. 1. The seismic volumes, of course, may not be limited to a “cube” geometry and may be formatted into any suitable volumetric geometry. Each seismic volume may have been processed or interpreted to contain one or more “horizons” 103A-103E in seismic volume 101. The horizons represent chronostratigraphic layers or surfaces within the particular seismic volumes.

The above described operations may be performed in any suitable seismic interpretation software package. Examples may include without limitation, Schlumberger Petrel® software, Paradigm Epos® software, Landmark DecisonSpace® software, and the like.

The disclosed methods are an alternative approach to boundary value problem solvers, based on mathematical geometry adapted to the nature of the acquired data, creating a significant algorithm speed-up (i.e. up to 80 times faster), especially when handling large and high density datasets (e.g. 1,000 km×1,000 km at 25 m resolution). Embodiments of the method use digital elevation model types of data. That is, for any given subsurface horizon each data point comprises a single elevation data value. In other words, for any given point (X, Y) in space, there is only one elevation value (Z). This is independent of how the data are acquired or calculated and could be coming from many different sources such as without limitation, seismic acquisition and interpretation, horizon modeling, auto-picked seismic horizons, etc.

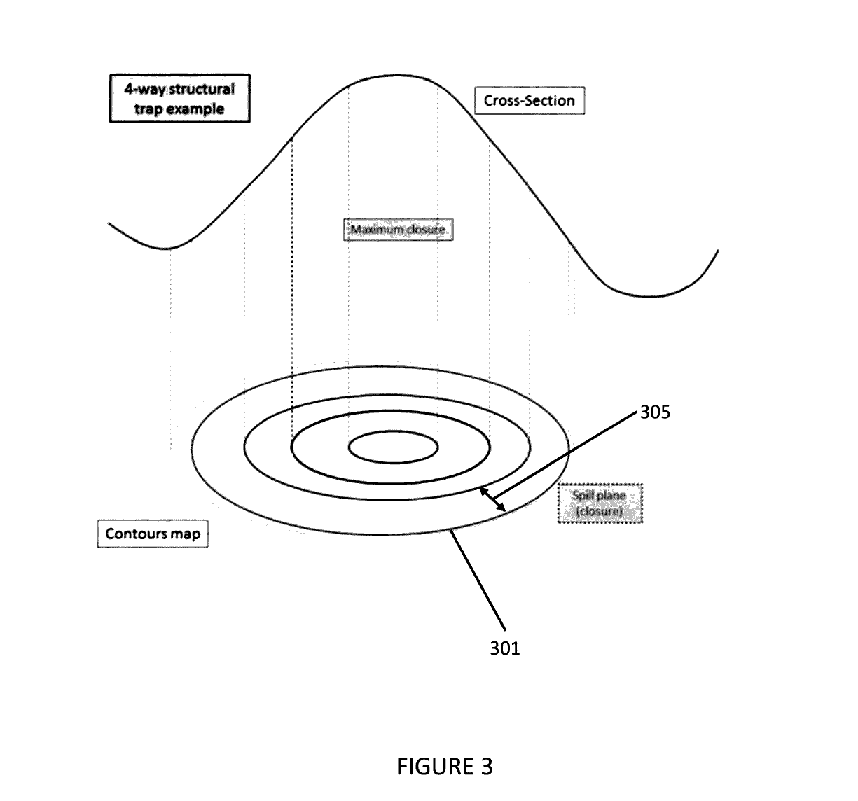

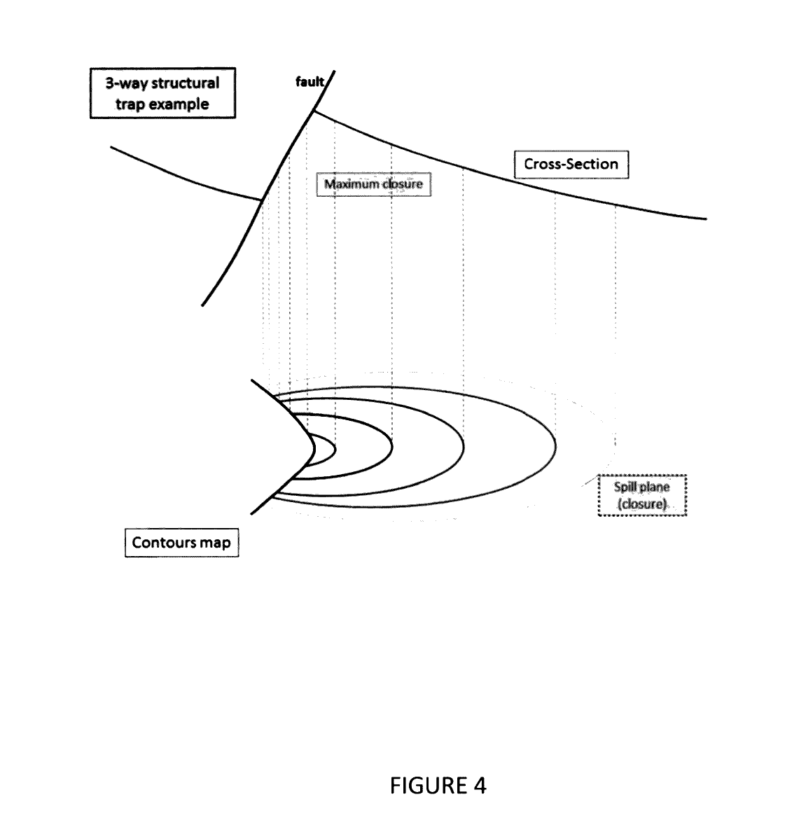

The purpose of the various embodiments of the method is to identify closures (4-way or a-way traps, see FIG. 3 and FIG. 4). Sub-surface traps may be classified in two categories: stratigraphic traps (caused by geologic depositional settings) and structural traps (caused by the Earth being bent and deformed in some ways). The most common structural trap is formed by a simple dome structure (called anticline) and is also known as “four-way closure”. Another type of structural trap bounded by faults (also known as “three-way closure”) is caused by the fracture and slippage of rocks along fault lines, bringing impermeable material and forming lateral barriers to hydrocarbon flow. Due to the nature of closures, an associated spill plane is generally flat, that is with a constant Z-elevation and its boundary is therefore the corresponding Z-elevation contour of the considered horizon. Knowing that, finding 4-way and 3-way closures basically entails finding the outermost contour of such structural traps (as long as the horizon is a single elevation model, as mentioned previously).

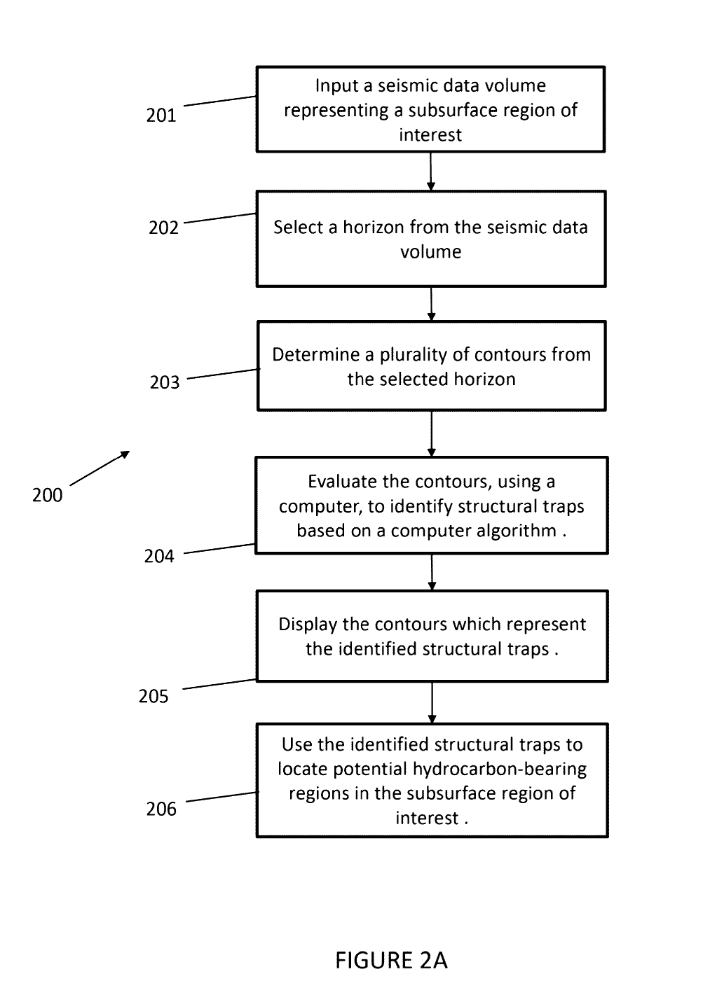

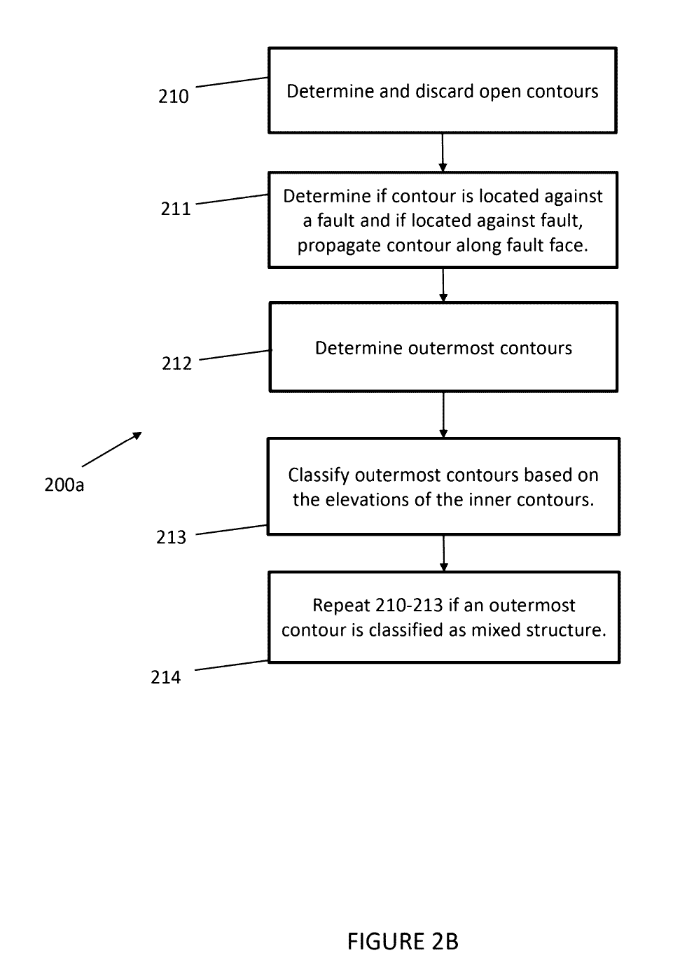

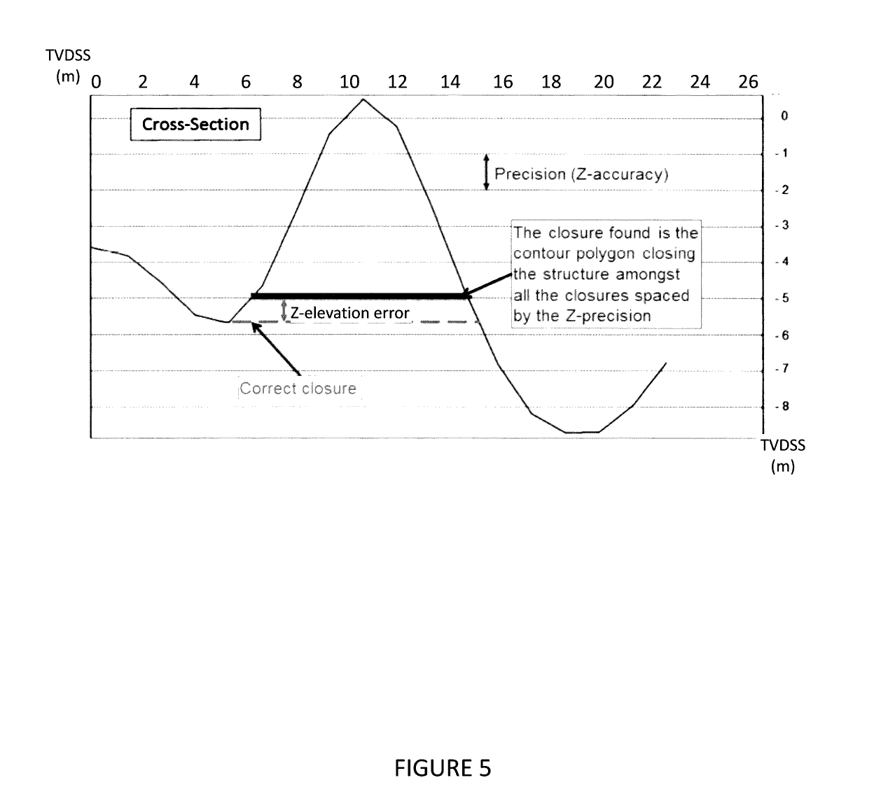

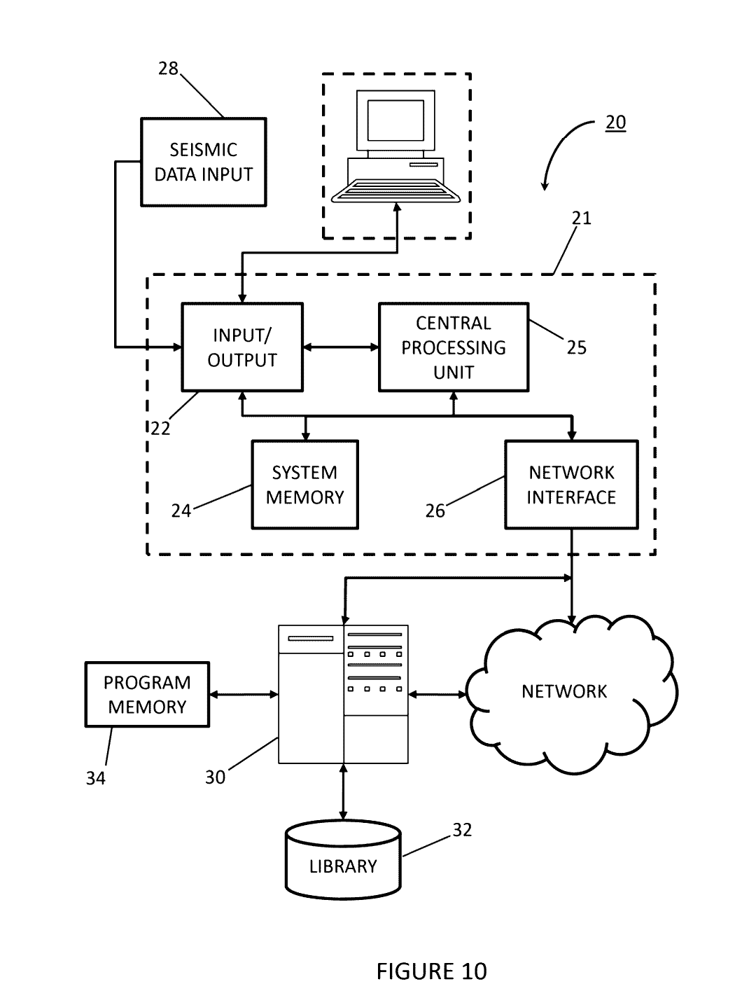

For any given stratigraphic horizon, now referring to FIGS. 2A-B, an embodiment of the method can generally include the following steps described below. In block 201, seismic data or a seismic dataset from a subsurface region of interest can be inputted into a computer system 20 as described and illustrated in FIG. 10. In block 202, one of the horizons 103 from the seismic dataset 101 may be selected. In block 203, the computer 20 can compute the elevation contours 301 spaced by a given step 305 from the data of the selected horizon as illustrated in FIGS. 2-5. This step value can be an input parameter corresponding to the elevation accuracy of the output result. The step value may in any suitable units and in any suitable range based on the available data contained in the seismic dataset. More specifically, the step value is the maximum elevation error that can be observed when obtaining the resulting spill planes (see FIG. 5). In the example shown in FIG. 5, the resulting closure elevation has an accuracy of 1 meter (i.e. its elevation, Z, is in [−5, −6] meters range although the true elevation of the actual closure is −5.68 m. As such, computer closure with a 0.1 m step of precision likely would result in a more accurate resulting closure of elevation [−5.6,−5.7] meters range.

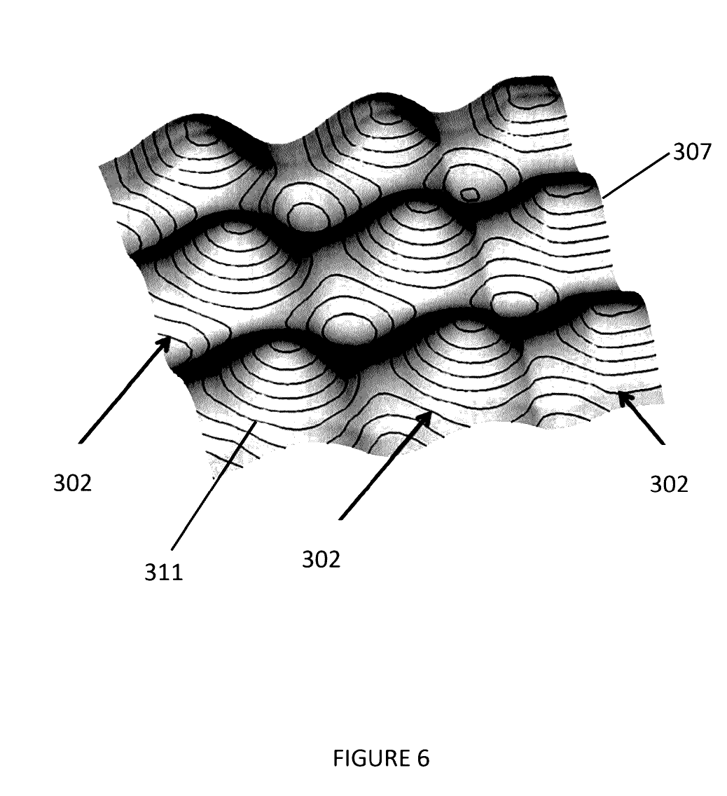

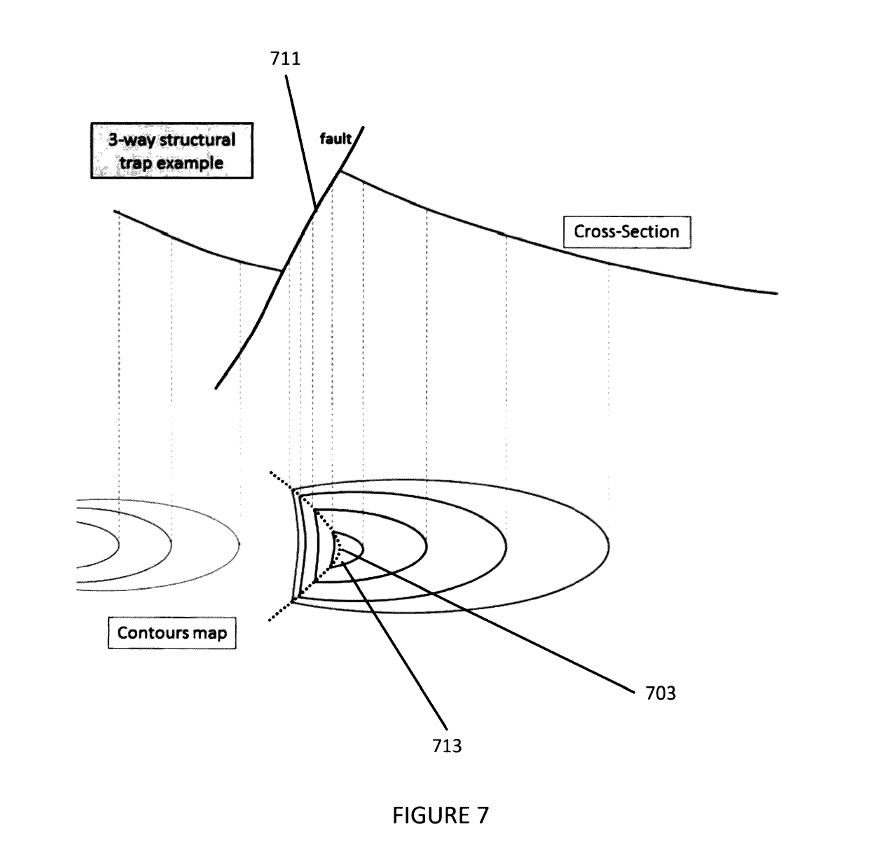

In 203, the contours are determined by the computer 20 based on the elevation data points using a computer algorithm which is described in more detail below. In block 204, contours are then evaluated against each other to identify the structural traps using a computer algorithm 200a which is described in more detail below and shown in FIG. 2B. Referring to FIG. 6, any calculated contour 302 terminating on the horizon boundary 307 can be considered open (i.e. the first point of the contour polygon or closure is not spatially equal to its last point) and is therefore discarded because it is incomplete (FIG. 6) in 210. A contour can be considered closed when each point is connected to exactly 2 other points by a segment. More particularly, a closed contour can be mathematically referred to as a polygon. In other words, a contour may be considered a finite chain of straight line segments, formed by the various data points in the seismic dataset, closing in a loop to form a closed chain or circuit. Referring to FIG. 7 and block 211, in a 3-way closure configuration, contours typically end up against faults 711. In that case, the contour lines are closed by propagating the contour 713 on the fault face along the same iso-value elevation (See FIG. 7).

In 212, the algorithm executed by computer 20 determines the outermost contours 311 (See FIG. 6). The principle behind the algorithm is that due to the inherent nature of contours, contours cannot cross each other. Therefore, to determine whether a contour is contained within another contour, the computer algorithm need only to test if a single point, in two-dimensional (2D) geometry, of a contour line lies inside the other contour polygon and vice-versa. That is, an outermost contour will not have having any contours located outside of it in 2D geometrical space.

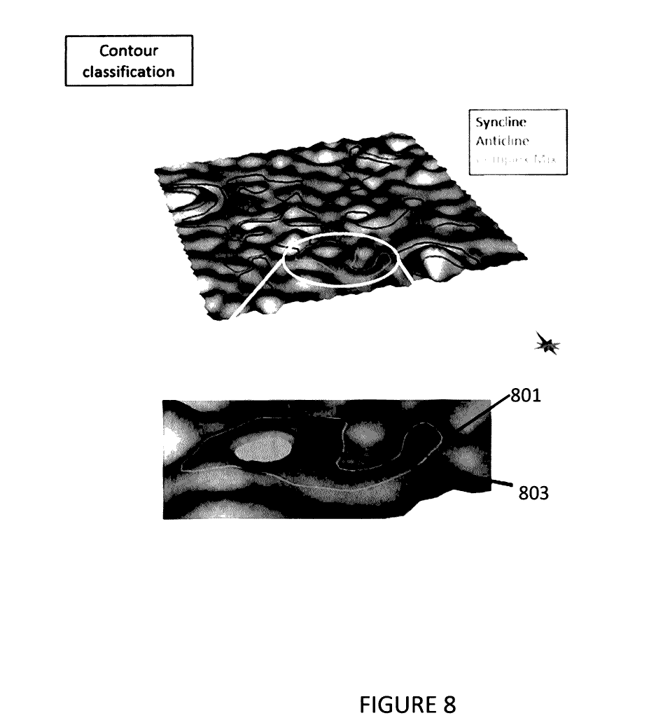

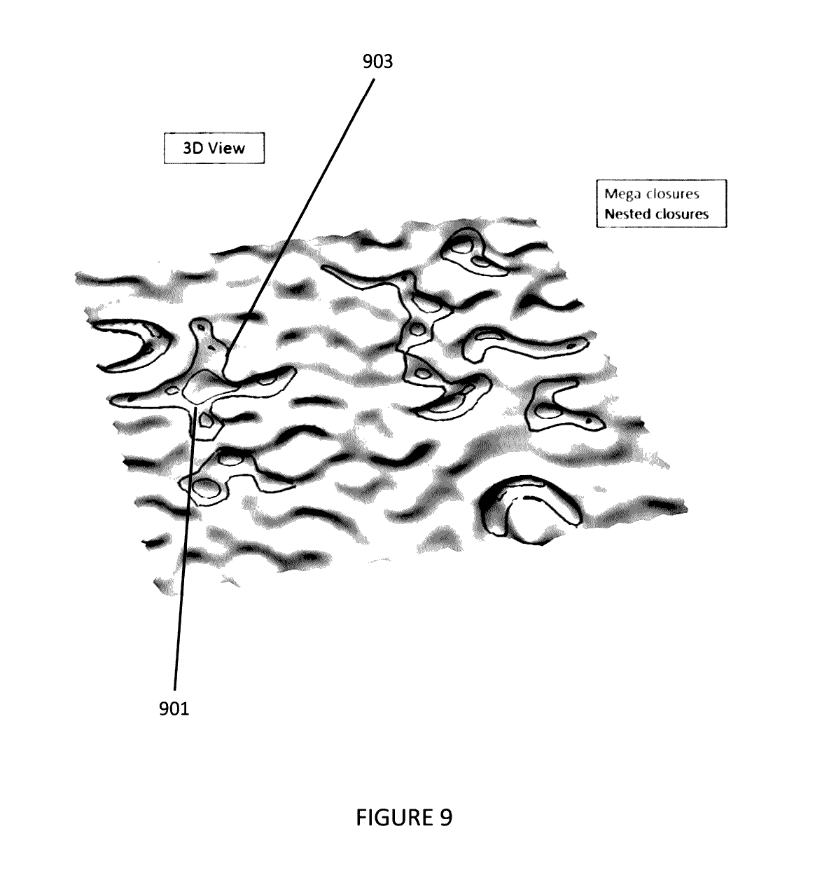

Still referring to 200a in FIG. 2b, contours left are not necessarily closures yet. Accordingly, algorithm 200a as executed by a computer may classify the closures or outermost contours as dome structures (anticline), reverse dome structures (syncline) or complex mixed structures. FIG. 8 shows a three dimensional example of a complex mixed structure 801 made of syncline 803 surrounded by anticlines and vice-versa. Reverse dome structures are not necessarily discarded since they can be stored for their potential use in basin modeling. When complex mixed structures are found, the workflow is re-run from 210 only within these complex mixed structures areas of interest. Regional scale contours representing a big area greater than a given threshold, may also be re-processed from 210 in order to find the nested prospect scale closures 901 within these large or mega-closures 903 (See FIG. 9). Referring back to FIG. 2A, remaining contours which are not identified as mixed structure may correspond to the spill plane outlines and may be identified as potential hydrocarbon traps. In 205 of FIG. 2A, the identified contours may be displayed by the computer as outlines of the identified traps as shown in FIGS. 8 and 9. In 206, the identified structural traps may then be used to help a seismic interpreter locate potential hydrocarbon-bearing regions in the subsurface region of interest defined by volume 101.

FIG. 10 illustrates, according to an example of an embodiment computer system 20, which may perform the operations described in this specification to perform the operations disclosed in this specification. In this example, system 20 is as realized by way of a computer system including workstation 21 connected to server 30 by way of a network. Of course, the particular architecture and construction of a computer system useful in connection with this invention can vary widely. For example, system 20 may be realized by a single physical computer, such as a conventional workstation or personal computer, or alternatively by a computer system implemented in a distributed manner over multiple physical computers. Accordingly, the generalized architecture illustrated in FIG. 10 is provided merely by way of example.

As shown in FIG. 10 and as mentioned above, system 20 may include workstation 21 and server 30. Workstation 21 includes central processing unit 25, coupled to system bus. Also coupled to system bus is input/output interface 22, which refers to those interface resources by way of which peripheral functions (e.g., keyboard, mouse, display, etc.) interface with the other constituents of workstation 21. Central processing unit 25 refers to the data processing capability of workstation 21, and as such may be implemented by one or more CPU cores, co-processing circuitry, and the like. The particular construction and capability of central processing unit 25 is selected according to the application needs of workstation 21, such needs including, at a minimum, the carrying out of the functions described in this specification, and also including such other functions as may be executed by computer system. In the architecture of allocation system 20 according to this example, system memory 24 is coupled to system bus, and provides memory resources of the desired type useful as data memory for storing input data and the results of processing executed by central processing unit 25, as well as program memory for storing the computer instructions to be executed by central processing unit 25 in carrying out those functions. Of course, this memory arrangement is only an example, it being understood that system memory 24 may implement such data memory and program memory in separate physical memory resources, or distributed in whole or in part outside of workstation 21. In addition, as shown in FIG. 5, seismic data inputs 28 that are acquired from a seismic survey are input via input/output function 22, and stored in a memory resource accessible to workstation 21, either locally or via network interface 26.

Network interface 26 of workstation 21 is a conventional interface or adapter by way of which workstation 21 accesses network resources on a network. As shown in FIG. 5, the network resources to which workstation 21 has access via network interface 26 includes server 30, which resides on a local area network, or a wide-area network such as an intranet, a virtual private network, or over the Internet, and which is accessible to workstation 21 by way of one of those network arrangements and by corresponding wired or wireless (or both) communication facilities. In this embodiment of the invention, server 30 is a computer system, of a conventional architecture similar, in a general sense, to that of workstation 21, and as such includes one or more central processing units, system buses, and memory resources, network interface functions, and the like. According to this embodiment of the invention, server 30 is coupled to program memory 34, which is a computer-readable medium that stores executable computer program instructions, according to which the operations described in this specification are carried out by allocation system 30. In this embodiment of the invention, these computer program instructions are executed by server 30, for example in the form of a “web-based” application, upon input data communicated from workstation 21, to create output data and results that are communicated to workstation 21 for display or output by peripherals in a form useful to the human user of workstation 21. In addition, library 32 is also available to server 30 (and perhaps workstation 21 over the local area or wide area network), and stores such archival or reference information as may be useful in allocation system 20. Library 32 may reside on another local area network, or alternatively be accessible via the Internet or some other wide area network. It is contemplated that library 32 may also be accessible to other associated computers in the overall network.

The particular memory resource or location at which the measurements, library 32, and program memory 34 physically reside can be implemented in various locations accessible to allocation system 20. For example, these data and program instructions may be stored in local memory resources within workstation 21, within server 30, or in network-accessible memory resources to these functions. In addition, each of these data and program memory resources can itself be distributed among multiple locations. It is contemplated that those skilled in the art will be readily able to implement the storage and retrieval of the applicable measurements, models, and other information useful in connection with this embodiment of the invention, in a suitable manner for each particular application.

According to this embodiment, by way of example, system memory 24 and program memory 34 store computer instructions executable by central processing unit 25 and server 30, respectively, to carry out the disclosed operations described in this specification, for example, by way of which structural traps may be identified. These computer instructions may be in the form of one or more executable programs, or in the form of source code or higher-level code from which one or more executable programs are derived, assembled, interpreted or compiled. Any one of a number of computer languages or protocols may be used, depending on the manner in which the desired operations are to be carried out. For example, these computer instructions may be written in a conventional high level language, either as a conventional linear computer program or arranged for execution in an object-oriented manner. These instructions may also be embedded within a higher-level application. Such computer-executable instructions may include programs, routines, objects, components, data structures, and computer software technologies that can be used to perform particular tasks and process abstract data types. It will be appreciated that the scope and underlying principles of the disclosed methods are not limited to any particular computer software technology. For example, an executable web-based application can reside at program memory 34, accessible to server 30 and client computer systems such as workstation 21, receive inputs from the client system in the form of a spreadsheet, execute algorithms modules at a web server, and provide output to the client system in some convenient display or printed form. It is contemplated that those skilled in the art having reference to this description will be readily able to realize, without undue experimentation, this embodiment of the invention in a suitable manner for the desired installations. Alternatively, these computer-executable software instructions may be resident elsewhere on the local area network or wide area network, or downloadable from higher-level servers or locations, by way of encoded information on an electromagnetic carrier signal via some network interface or input/output device. The computer-executable software instructions may have originally been stored on a removable or other non-volatile computer-readable storage medium (e.g., a DVD disk, flash memory, or the like), or downloadable as encoded information on an electromagnetic carrier signal, in the form of a software package from which the computer-executable software instructions were installed by allocation system 20 in the conventional manner for software installation.

While the embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

The discussion of a reference is not an admission that it is prior art to the present invention, especially any reference that may have a publication date after the priority date of this application. The disclosures of all patents, patent applications, and publications cited herein are hereby incorporated herein by reference in their entirety, to the extent that they provide exemplary, procedural, or other details supplementary to those set forth herein.

What is claimed is:

1. A method of identifying structural traps comprising:
(a) inputting a seismic dataset into a computer, the seismic dataset representative of a subsurface region of interest, and wherein the seismic dataset comprises at least one or more elevation data points;
(b) selecting a horizon from the seismic dataset;
(c) determining, using the computer, a plurality of elevation contours from the horizon based on the elevation data points to generate a contour dataset;
(d) evaluating, using the computer, the plurality of contours to identify one or more structural traps, wherein the one or more structural traps are identified automatically based upon a computer algorithm which uses the elevation data points to identify and classify the one or more structural traps;
(e) displaying on the computer one or more contours which represents an outline of the one or more structural traps; and
(f) using the one or more structural traps identified in (d) to locate potential hydrocarbon-bearing regions in the subsurface region of interest.

2. The method of claim 1, wherein (b) comprises selecting and inputting a step value for spacing of each contour:

3. The method of claim 1, wherein the computer algorithm in (d) executes the following operations:
(i) determining whether each contour is an open contour and discarding all open contours;
(ii) identifying one or more outermost contours, each outermost contour enclosing one or more inner contours; and
(iii) determining whether each outermost contour is a structural trap based on the one or more inner contours contained within the outermost contour.

4. The method of claim 4 wherein (iii) comprises classifying each outermost contour as at least one of an anticline, a syncline, a structural trap, or a mixed structure.

5. The method of claim 4, if an outermost contour is classified as a mixed structure, further comprising repeating (i) through (iii) for the outermost contour and the inner contours contained within the outermost contour.

6. The method of claim 1, if a contour abuts a fault, wherein (c) further comprises propagating the contour along the fault.

7. The method of claim 1, further comprising repeating (b) through (f) for different horizons in the seismic dataset.

8. The method of claim 1 wherein the structural traps comprises a three way trap, a four way trap, or combinations thereof.

9. A computer system, comprising:
an interface for receiving a plurality of seismic input volumes, the seismic input volumes comprising a plurality of seismic traces and one or more horizons;
a memory resource;
input and output functions for presenting and receiving communication signals to and from a human user;
one or more central processing units for executing program instructions; and program memory, coupled to the central processing unit, for storing a computer program including program instructions that, when executed by the one or more central processing units, cause the computer system to perform a plurality of operations comprising:
(a) receiving a seismic dataset, the seismic dataset representative of a subsurface region of interest, and wherein the seismic dataset comprises at least one or more elevation data points;
(b) determining a plurality of elevation contours from a selected horizon based on the elevation data points to generate a contour dataset;
(c) evaluating the plurality of contours to identify one or more structural traps, wherein the one or more structural traps are identified automatically based upon a computer algorithm which uses the contour dataset;
(d) displaying on the computer one or more contours which represents an outline of the one or more structural traps; and
(e) using the one or more structural traps identified in (c) to locate potential regions in the subsurface region of interest which could produce hydrocarbons.

10. The system of claim 9, wherein (b) comprises using a step value for spacing of each contour based on a selected step value from a user.

11. The system of claim 9, wherein the computer algorithm in (c) executes the following operations:
(i) determining whether each contour is an open contour and discarding all open contours;
(ii) identifying one or more outermost contours, each outermost contour enclosing one or more inner contours; and
(iii) determining whether each outermost contour is a structural trap based on the one or more inner contours contained within the outermost contour.

12. The system of claim 11 wherein (iii) comprises classifying each outermost contour as at least one of an anticline, a syncline, a structural trap, or a mixed structure.

13. The system of claim 11, if an outermost contour is classified as a mixed structure, further comprising repeating (i) through (iii) for the outermost contour and the inner contours contained within the outermost contour.

14. The system of claim 9, if a contour abuts a fault, wherein (c) further comprises propagating the contour along the fault.

15. The system of claim 9, further comprising repeating (b) through (d) for different horizons in the seismic dataset.

16. The system of claim 9 wherein the structural traps comprises a three way trap, a four way trap, or combinations thereof.
